(19) United States
(12) Patent Application Publication
(10) Pub. No.: US 2024/0353978 A1
(43) Pub. Date: Oct. 24, 2024

(54) INTERACTION METHOD AND APPARATUS, ELECTRONIC DEVICE, AND COMPUTER READABLE STORAGE MEDIUM

(71) Applicant: Beijing Bytedance Network Technology Co., Ltd., Beijing (CN)

(72) Inventors: Ruyu JIANG, Beijing (CN); Ruicheng WANG, Beijing (CN)

(21) Appl. No.: 18/571,005

(22) PCT Filed: Jun. 16, 2022
(86) PCT No.: PCT/CN2022/099245

§ 371 Date: Dec. 15, 2023

(30) Foreign Application Priority Data
Jun. 16, 2021 (CN) 202110663948.5

(51) Int. Cl. G06F 3/0484; G06F 3/0481

(52) U.S. Cl. CPC G06F 3/0484; G06F 3/0481

(57) ABSTRACT

An information interaction method, an information interaction apparatus, an electronic device, and a computer-readable storage medium are provided. The information interaction method includes: displaying interaction information in a target interface of a first program; invoking a second program interface in response to an invocation signal being triggered by the interaction information; initiating a second program by invoking the second program interface, and displaying the second program in a display panel; and operating or switching the second program.

The present application claims the priority of China Patent Application No. 202110663948.5, titled “INTERACTION METHOD AND APPARATUS, ELECTRONIC DEVICE, AND COMPUTER READABLE STORAGE MEDIUM” filed on Jun. 16, 2021 in China National Intellectual Property Administration, the entirety of which are incorporated into the present application by reference.

### TECHNICAL FIELD

The embodiments of the present disclosure relate to the field of interaction display, in particular to an interaction method and apparatus, an electronic device and a computer-readable storage medium.

### BACKGROUND

With the advancement of network technology and livestream technology, the influence of network media in the society is increasing, and a variety of abundant media contents are obtained by users through network distribution, and many media contents attract the attention and resonance of users and form trending or topics, thereby arousing the continuous attention and discussions of users. With the rapid development of the network livestream industry, the interaction between livestream and users has become more abundant and more convenient.

In the current livestream interaction technology, the interaction operation of users is inconvenient, affecting the usage experience.

### SUMMARY

The content of the invention is provided to introduce the ideas in a brief form, and these ideas are described specifically in the detailed description section below. The content of the invention neither aims at marking the essential features or necessary features of the technical solution for which protection is claimed, nor aims at being used to limit the scope of the technical solution that is claimed for protection.

In order to solve the above technical problems and improve the user experience, the embodiments of the present disclosure propose the following technical solutions.

In the first aspect, the embodiments of the present disclosure provide an information interaction method, which includes: displaying interaction information in a target interface of a main program; invoking a popover program interface in response to an invocation signal being triggered by the interaction information; initiating the popover program by invoking the popover program interface, and displaying the popover program in a display panel in a form of a popover; and operating or switching the popover program. The display panel is a certain area in the target interface.

Further, the invoking a popover program interface in response to the invocation signal being triggered by the interaction information, includes: determining whether the invoking is valid; and generating a valid invocation instruction in the case where the invoking is determined to be valid, and invoking the popover program interface based on the valid invocation instruction.

Further, the determining whether the invoking is valid includes: determining whether the invoking is valid according to the embedded authentication information between the popover program and the main program. In response to the embedded authentication information between the popover program and the main program being present, the invoking is valid, and in response to the embedded authentication information between the popover program and the main program being absent, the invoking is invalid.

Further, the main program is a livestream program, a game program, or a video program, and the target interface of the main program is a livestream interface, a game interface, or a video interface.

Further, the display panel is allowed for position dragging in accordance with the content distribution in the target interface of the main program, and the position after dragging is any position in the target interface.

Further, the display panel is allowed for adjusting a size in the target interface of the main program.

Further, the display panel has a transparency in the target interface of the main program, and the transparency is adjusted in a range from 0 to 100.

Further, the popover program performs the embedded display and operation in the main program. The display panel serves as a display window of the popover program, and the popover serves as an operation interface of the popover program.

Further, the popover program is an e-commerce service program, a social program, or a game program, and a user performs a shortcut operation on the popover program through the popover of the display panel.

Further, the popover is a shortcut operation option of the popover program, and after the user performs an operation through the shortcut operation option, the popover is switched to another shortcut operation option until the user completes the operation.

Further, both of the display panel and the popover program are set to one or more than one.

Further, in the case where the popover programs are more than one, more than one popover programs are displayed in the same display panel or in different display panels.

Further, the popover program includes the first popover program and the second popover program. The first popover program is initiated in the display panel based on the invoking, the second popover program is an associated program of the first popover program, and the second popover program is initiated by the first popover program in the popover.

In the second aspect, the embodiments of the present disclosure provide an information interaction apparatus, which includes a display module, an invocation module, an initiating module, a display panel module, and an operation module. The display module is configured to display interaction information in a target interface of a main program. The invocation module is configured to in response to an invocation signal being triggered by the interaction information, invoking a popover program interface. The initiating module is configured to initiate a popover program by invoking the popover program interface, and to display the popover program in a display panel in a form of a popover, and the display panel is a certain area in the target interface. The operation module is configured to operate or switch the popover program.

In the third aspect, the embodiments of the present disclosure provide an electronic device, which includes a memory and a processor.

The memory is configured to store computer-readable instructions.

The processor is configured to execute the computer-readable instructions, so that the electronic device implements the method of any one in the first aspect.

In the fourth aspect, the embodiments of the present disclosure provide a non-transient computer-readable storage medium storing the computer-readable instructions. The computer-readable instructions upon execution by a computer, cause the computer to implement the method of any one in the first aspect.

The above description is only an overview of the technical solutions of the present disclosure. In order to understand the technical solutions of the present disclosure better, thereby implementing the technical solutions in accordance with the contents of the specification, and in order to make the above description and other purposes, features and advantages of the present disclosure more apparent and easier to understand, the following is the detailed description of preferred embodiments with the accompanying drawings.

### BRIEF DESCRIPTION OF THE DRAWINGS

Combined with the accompanying drawings and referring to the following specific embodiments, the above description and other features, advantages and aspects of each embodiment of the present disclosure become more obvious. Throughout the accompanying drawings, the same or similar reference numbers indicate the same or similar elements. It is understood that the accompanying drawings are schematic and that the originals and elements are not necessarily drawn to scale.

FIG. 1 is a flowchart diagram of the information interaction method provided by the embodiments of the present disclosure;

FIG. 2 is a diagram of an interaction interface provided by the embodiments of the present disclosure;

FIG. 3 is a diagram of another interaction interface provided by the embodiments of the present disclosure;

FIG. 4 is a diagram of still another interaction interface provided by the embodiments of the present disclosure;

FIG. 5 is a diagram of an information interaction apparatus provided by the embodiments of the present disclosure; and

FIG. 6 is a structure diagram of an electronic device provided according to the embodiments of the present disclosure.

### DETAILED DESCRIPTION

The embodiments of the present disclosure are described in more detail below with reference to the accompanying drawings. Although certain embodiments of the present disclosure are illustrated in the accompanying drawings, it is understood that the present disclosure is implemented in various forms and is not interpreted as being limited to the embodiments described herein, but rather provide these embodiments to understand the present disclosure more thoroughly and completely. It is understood that the accompanying drawings and embodiments of the present disclosure are used for exemplary purposes only and are not used to limit the protection scope of the present disclosure.

It is understood that the individual steps described in the method embodiments of the present disclosure are executed in different sequences, and/or in parallel. In addition, the method embodiments include additional steps and/or omit the steps illustrated for execution. The scope of the present disclosure is not limited in this respect.

The term “including” or “comprising” and its variations used herein are open-ended comprising, i.e. “including but not limited to”. The term “based on” is “at least partially based on”. The term “an embodiment” denotes “at least one embodiment”. The term “another embodiment” denotes “at least one additional embodiment”. The term “some embodiments” denotes “at least some embodiments”. The definitions of other terms are given in the description below.

It is noted that the concepts of “first”, “second”, and so on mentioned in the present disclosure are only used to distinguish different apparatuses, modules or units, and are not used to limit the order or interdependence of the functions executed by the apparatuses, modules or units.

It is noted that the wording of “one” or “more” mentioned in the present disclosure is schematic rather than restrictive, and those skilled in the art understand that, unless otherwise explicitly stated in the context, it is understood as “one or more”.

In the research process, the applicant finds that in the current livestream interaction technology, the interaction chat with a live-streamer is operated directly in the livestream program, without relating to other associated programs. Taking the resource service in the process of the live-streamer performing livestream ecommerce as an example, in response to resource purchasing, for example, in a resource purchasing program or resource transferring program, in general, the program switching is performed, leaving the livestream program and entering the third-party program to operate, and the process is presented as page redirection, e.g., redirecting from the livestream page to the interface of the resource purchasing program. The resource purchasing operation is performed in the purchasing interface. During the purchasing process, the resource transferring operation is encountered, and in this case, the interface redirects to the resource transferring interface. For another example, in the case where a relevant operation (such as the voting operation) is performed on a certain resource, the relevant program (such as the voting program) performs the program switching. Leaving the livestream program, and entering the third-party program to operate, the process is presented as the page redirection, e.g., redirecting from the livestream page to the voting program interface. The continuous transformation of the interface causes the disruption of the livestream, and the operation is inconvenient, resulting in the poor user experience.

To solve the above problems, the embodiments of the present disclosure provide an interaction method and apparatus, an electronic device, and a computer-readable storage medium.

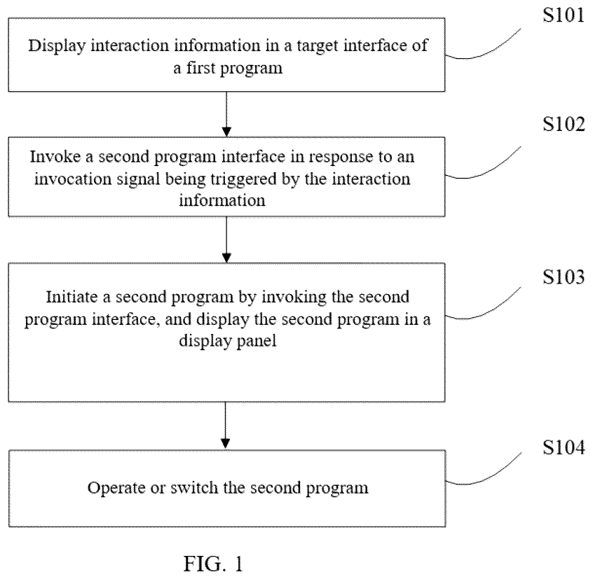

FIG. 1 is a flowchart diagram of an information interaction method provided by the embodiments of the present disclosure, the information interaction method provided by the embodiments of the present disclosure is executed by an information interaction apparatus, the information interaction apparatus is implemented as a software, or implemented as a combination of software and hardware, alternatively, the information interaction apparatus is integrated in a device of the interaction system, such as a terminal device. As illustrated in FIG. 1, the information interaction method includes the following steps:

Step S101: displaying interaction information in a target interface of a main program.

In Step S101, for example, the target interface of the main program is displayed on the screen of a terminal device, the target interface fills the screen or occupies a portion of the screen. In the present embodiment, taking examples that the target interface of the main program is a livestream program, and the livestream interface fills the screen (not limited to a full screen), the target interface displays the interaction information, and the interaction information includes comment information, advertising information, hot information, news, shopping information, and member information. The livestream interface of the live-streamer is the target interface of the main program, the interaction information is displayed in a scrolling manner in the form of bullet comments, or displayed in a page turning manner, or displayed in other manners. The interaction information usually occupies a portion of the livestream interface, for example, the interaction information occupies the upper, central or lower portion of the interaction interface, and alternatively, the interaction information occupies one side (left or right) of the upper, central or lower portion. The interaction information is displayed in a clustering manner in the form of a collection of topics or in the form of information types. The interaction information is selected or clicked. The user finds the interaction information of interest in the process of watching the livestream and triggers the invocation signal of the relevant information by clicking on the interaction information, in order to invoke the third-party program to perform the display operation in the interface of the main program. Optionally, the main program is a livestream program, a game program, a video program, a document program, a network information platform program, or the like, and the corresponding target interface of the main program is a livestream interface, game interface, video interface, document interface, or network information platform interface.

Step S102: invoking a popover program interface in response to an invocation signal being triggered by the interaction information.

In Step S102, the interaction information is selected or clicked. The user finds the interaction information of interest in the process of watching the livestream, and triggers the invocation signal of the relevant information by clicking on the interaction information. In the case where the interaction information is clicked or pre-clicked by a user, the interaction information is presented as a short stay and/or a larger information font and/or a change in the color of the information and/or a flash of special effect expressions, in order to prompt the user to perform the clicking operation. The pre-clicking herein is the case where the user moves a mouse or a touch point to the interaction information without actually clicking. After the main program detects the invocation signal which is triggered by the user, the main program applies to invoke the third-party program interface, and requests to invoke the third-party program. The operation of invoking the popover program interface in response to the invocation signal being triggered by the interaction information requires to determine whether the invoking is valid. In the case where the invoking is determined to be valid, a valid invocation instruction is generated, and then the popover program interface is invoked. In one example, the popover program interface is invoked based on the valid invocation instruction. In addition, not all of the third-party programs can embed the display operation in the interface of the main program, and then whether there is embedded authentication information between the third-party program and the main program is required to be determined. The determining whether the invoking is valid includes: determining whether the invoking is valid according to the embedded authentication information between the popover program and the main program. In response to the embedded authentication information between the popover program and the main program being present, the invoking is valid, and in response to the embedded authentication information between the popover program and the main program being absent, the invoking is invalid. The third-party program is invoked to perform the display operation in the interface of the main program only in the case where the invoking is valid.

Step S103: initiating a popover program by invoking the popover program interface, and displaying the popover program in a display panel in the form of a popover, in which the display panel is a certain area in the target interface.

In one example, a certain area is divided in advance from the target interface in order to serve as the display panel, serving as the display area of the popover program. In another example, after executing the step of S102 and before executing the step of S103, a certain area is divided from the target interface in order to serve as the display panel, serving as the display area of the popover program.

For example, in the case where the main program is a livestream program, when a live-streamer is live-streaming, optionally, the livestream interface is displayed by filling the screen, and the interaction information is displayed in a certain position of the livestream interface. For example, the interaction information occupies the upper, central or lower portion of the interaction interface, and alternatively, occupies one side (left or right side) of the upper, central or lower portion. The interaction information is displayed in a scrolling manner in the form of bullet comments, or displayed in a page turning manner. A user triggers the invocation signal by clicking, the main program invokes the popover program interface in respond to the invocation signal, and after, the popover program as a third-party program, divides a certain area from the livestream interface of the main program as a display panel, serving as the display area of the popover program. The display panel is allowed for position dragging in accordance with the content distribution in the target interface of the main program, the position after dragging is any position in the target interface. The display panel is allowed for adjusting a size in the target interface of the main program. The user adjusts the position and size of the display panel according to the change of the content in the livestream interface, in order to avoid obscuring the content that the user is concerned about. Specifically, the user selects the display panel area through the touch screen or mouse, drags the position of the display panel, and adjusts the size of the display panel by the method of the two-point expansion of the touch screen, or adjust the size using the mouse at the edge of the display panel area. In addition, the display panel has a transparency in the target interface of the main program, and the transparency is adjusted in the range from 0 to 100. The display panel only serves as a display window or display carrier of the popover program, there is a popover content on the display panel, the popover content corresponds to an operation option of the popover program, and the user performs the operation on the operation options of the popover program. The display panel is set to be one or more than one, the position is usually set at the bottom of the target interface, of course, the position is set at any position in the target interface according to the need of the user, the position is set side-by-side in landscape or portrait orientation, or the position is set in diagonal orientation.

In Step S103, in the target interface of the main program, the display panel serving as a display carrier, the popover program is initiated by the invoking of the popover program interface. Taking a livestream program serving as the main program as an example, in the case where a live-streamer is live-streaming, after the user clicks on the interaction message, the popover program is initiated in the display panel of the livestream interface, and the popover program performs an embedded display and operation in the main program. The display panel serves as a display window of the popover program, and the popover serves as an operating interface of the popover program. The popover program is a third-party program, and the popover program has a shortcut operation and an attribute of being able to operate transfer, so that the popover program is embedded in the main program for the shortcut operation. Whether the invoking is valid is determined according to the embedded authentication information between the popover program and the main program. In response to the embedded authentication information between the popover program and the main program being present, the invoking is valid to perform a valid operation, and in response to the embedded authentication information between the popover program and the main program being absent, the invoking is invalid and the valid operation cannot be performed. The third-party program is invoked only in the case where the embedded authentication information exists and the valid invoking is formed. The third-party program is displayed in the display panel in the target interface of the main program in the form of a popover, and the user operates according to displayed operation options.

The popover program is, but not limited to be, an e-commerce service program, a resource transferring program, a social program, or a game program, and the user performs a shortcut operation on the program through the popover of the display panel. Optionally, the popover program is one or more than one, in a case where the popover programs are more than one, more than one popover programs are displayed in the same display panel or in different display panels.

Step S104: operating or switching the popover program;

In Step S104, the user selects the interaction information of interest, by a clicking operation, for example. After the authentication is valid, the relevant popover program is initiated. For example, the user is interested in relevant information of the interaction information, the user clicks on the relevant information of the interaction information, and the popover program is displayed in the display panel of the main program interface in the form of a popover. The popover is a shortcut operation option of the popover program. After the user operates through the shortcut operation option, the popover switches to another shortcut operation option until the user completes the operation. The popover program is an e-commerce service program, a resource transferring program, a social program, or a game program. The user performs the shortcut operation on the popover program through the popover of the display panel, such as a resource transferring application. The user performs the selection operation through the popover option. In the case where the relevant operation is not found on the popover page, the scrolling operation is performed, or the next page option is displayed for the user to select, another popover page is switched, and the user operates more than one times until finds the relevant operation option.

The specific implementation is that a main program invoking the correspondence relationship between the application type and the system function, or the correspondence relationship between the application type and the user resource, or the process of invoking the correspondence relationship between the application type and the system function and the user resource, and the process of loading the popover. By establishing the correspondence relationship between the functional area on the widget interface and the application type, after acquiring the functional area of the widget interface being acted by a touch operation of the user, the application type corresponding to the touch operation in the correspondence relationship is determined, and the system functions and/or the user resources corresponding to different application types are invoked. The invoked system functions and/or the user resources are loaded onto the popover, and the popover is displayed, so that the user implements the relevant operation without starting the widget application program, thereby simplifying the operation of the user. By loading an interface control of the file management, the user resource is loaded on the user resource display area layout by using the method of the file management loading the resource. By artificially establishing the correspondence relationship between user resources and popovers in advance, the popover program required by users is loaded on the corresponding popover. It is noted that a popover has a plurality of split screens, each popover program is configured to display a system function and a user resource, also configured only to display the system function, configured only to display the user resource. The plurality of popover programs in the popover of the embodiments of the present invention have a system function display area layout and a user resource display area layout, are also used for the operation program that is embedded in the main program and is closely related to the main program, and are also a third-party application after authentication. The display is the paginated display, or is the simultaneous side-by-side display.

Widget is a free and open-source desktop application platform launched by Yahoo, including a Widget engine and a Widget tool. Widget greatly facilitates the network operation of the user and improves the desktop application of the user. The Widget engine provides an Ajax application platform, and is used in Windows and Mac OS X operating system environments. A variety of Widget tools are executed on this platform after installing the Widget engine, similar to the desktop gadgets for Win7.

In an embodiment of the present disclosure, the touch operation acting on the Widget interface is acquired, the corresponding popover application type is determined according to the functional area acted by the touch operation, the corresponding system function and/or user resource are determined according to the popover application type, and the system function and/or user resource corresponding to the functional area of the widget are determined, the determined system function and/or user resource are loaded on the popover corresponding to the display panel of the main program, and the popover is displayed. Through the above method, the third-party program is displayed in the target interface of the main program in the form of the popover, and the operation of the third-party program is performed in the form of a popover program, without the page redirecting and the program switching, and avoiding affecting the perceptual experience of the user during the main program executing. Further, the nested association operation of the plurality of third-party programs can be performed. The display panel is also set to a certain degree of transparency, which is convenient for the nested interface display of the main program and the third-party program, improving the usage experience. In other words, the present embodiment loads the determined system function and/or user resource on the popover and displays the determined system function and/or user resource to the user, so that more information and functions are provided to the user without requiring the user to open each application, simplifying the usage operation and improving the experience of the user.

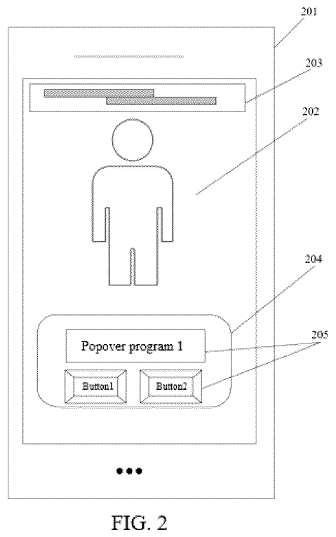

As illustrated in FIG. 2, the display interfaces of a main program and a popover program are described illustratively. Taking the electronic device being a mobile phone 201 as an example, illustratively; the main program executing in the mobile phone is a livestream program, a target interface of the main program is the livestream interface 202, the livestream interface is a real-time live picture or recorded picture, and is displayed in the form of filling a screen. The interactive information area 203 is displayed in the upper area of the livestream interface, and the related interactive information is scrolling displayed. The user clicks or pre-clicks on the interactive information, and the interface invoking of the popover program is triggered after clicking on the relevant interaction information. In the case where the invoking is determined to be valid, a certain area is divided from in the target interface as a display panel 204, the display panel 204 is illustrated as the lower area of FIG. 2. In the display panel, the popover program is started, the popover program 205 is displayed in the form of the popover. The popover program includes the relevant description of the popover program which includes the introduction of the popover program, the resource transferring description, the developer, the program version, and other information, and the popover program further includes operation options. The user operates the operation options, after operating, the user enters another popover interface or completes the operation directly. The user also slides the popover page, after the operation of sliding, the popover program enters another popover operation interface until the user finds the corresponding operation. The display panel is set to be a transparent background, and the transparency of the transparent background is adjustable from 0 to 100. By the nested popover display method, the user performs the popover operation in the target interface of the main screen, without affecting the viewing of the livestream contents, avoiding the page switching between programs, which is convenient and fast, thereby significantly improving the experience of the user.

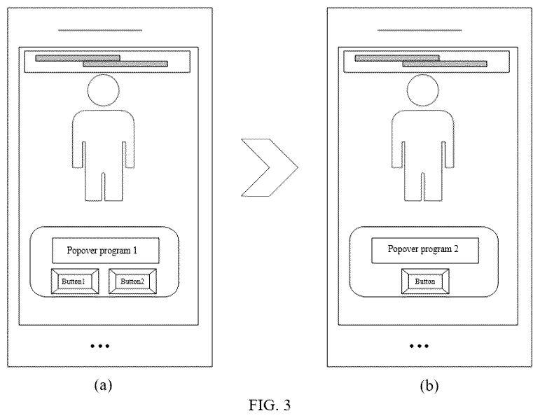

In an optional embodiment, the popover program includes the first popover program and the second popover program, the first popover program is initiated in the target interface based on the invoking, the second popover program is an associated program of the first popover program, and is initiated by an invocation of the first popover program in the popover. The first popover program is an e-commerce service program or a game program, and the associated second popover program is a resource transferring program. In this case, the embedded authentication information between the first popover program and the main program, and the embedded authentication information between the second popover program and the main program are both required. As illustrated in FIG. 3 (a), after the user selects the interaction information of interest, the associated first popover program is invoked and initiated, the operation on the operation option of the first popover program is performed. For example, in the case where the first popover program is a shopping platform program, the user selects the shopping options in the first popover program of the display panel, and after selecting the corresponding product, the resource transferring for the product is required. The resource transferring program is the second popover program distinct from the first popover program, as illustrated in FIG. 3 (b). The second popover program (i.e., the resource transferring program) associated with the first popover program is required to be invoked for the user selecting the product and performing the resource transferring operation, and the user performs the resource transferring operation in the second popover program. Optionally but not restrictively, the first popover program is an e-commerce service program, a game program, a content recommendation program, an advertising program, a social program, or the like, and the associated second popover program is a resource transferring program, a content display program, a social program, or the like. The user is clicking. Further, the popover program further includes the third popover program, the fourth popover program, . . . , the N^{th} popover program, where N is a natural number.

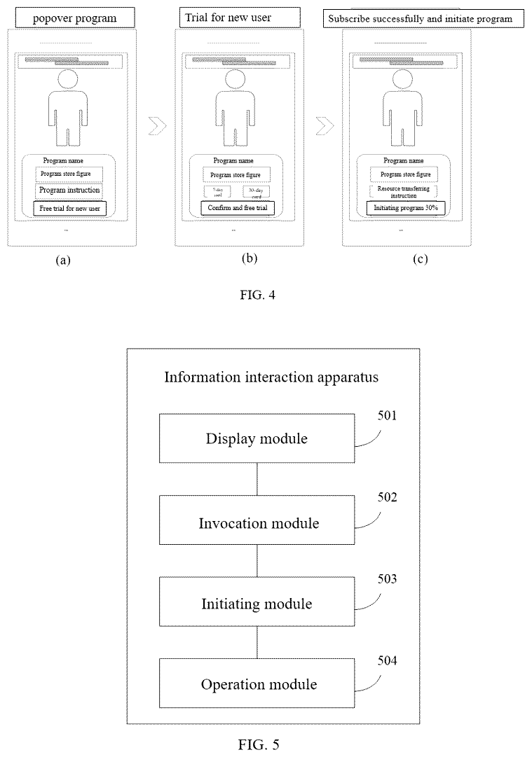

In an optional embodiment, the popover program is an operation program for association invoking, the operation program for association invoking serves as the first popover program, and the third-party program invoked by the operation program serves as the second popover program. As illustrated in FIG. 4, for example, the popover program is a resource transferring popover program, and the resource transferring popover program is embedded in the main program in an embedded form. In response to the user being interested in the resource transferring popover program, and clicking the relevant pushed information in the interaction information, the main program invokes the resource transferring program to display in the display panel of the target interface, the information and operation options of the resource transferring program are displayed in the form of the popover, and the user performs the relevant operation on the popover. FIG. 4 (a) and FIG. 4 (b) illustrate the operation options of the first popover program, which are the relevant operations of the associated operation program invoked by the main program. As illustrated in FIG. 4 (a), the display panel displays the name of the popover program, a figure of the program store, an introduction of the program, and an operation button. The operation button is specifically named as “free trial for new user”, after the user clicks the operation button, the popover program in the display panel switches to another popover operation interface, as illustrated in FIG. 4 (b), and the popover program content changes accordingly. The introduction of the program is changed to the option content “7-day card” and “30-day card”, and the operation button is changed to “confirm agreement and try it for free”. Such that, the popover program is considered as the operation program invoked by the main program, and serves as the first popover program. After clicking the operation button of “confirm the agreement and try it for free”, another popover page is entered. As illustrated in FIG. 4 (c), the “7-day card” and “30-day card” in the previous popover page are changed to “resource transferring illustration”, the operation button is changed to “30% in program initiation”, the relevant program is initiated after 100% in program initiation, and serves as the second popover program to continue operating in the display panel in the form of the popover until the user completes the program operation. During the entire operation process of the user, the program distinct from the main program keeps operating in the main program interface in the form of the popover, a plurality of popover programs are nested, and the livestream interface is never interrupted, without affecting the user to watch the livestream, watch videos, play games, and etc.

FIG. 5 is a structure diagram of an information interaction apparatus embodiment provided by the embodiments of the present disclosure. As illustrated in FIG. 5, the apparatus 500 includes: a display module 501, an invocation module 502, an initiating module 503, and an operation module 504.

The display module 501 is configured to display interaction information in the target interface of the main program. The target interface fills a screen or occupies a portion of a screen. The livestream interface of a live-streamer is the target interface of the main program, the interaction information is displayed in a scrolling manner in the form of bullet comments, or displayed in a page turning manner, or other display manners. The interaction information usually occupies a portion of the livestream interface, for example, the interaction information occupies the upper, central or lower portion of the interaction interface, and alternatively, occupies one side (left or right side) of the upper, central, or lower portion. The interaction information is also displayed in a clustering manner in the form of a collection of topics or in the form of information types. The interaction information is selected or clicked. The user finds the interaction information of interest in the process of watching the livestream, and triggers the invocation signal of the relevant information by clicking on the interaction information, so that the third-party program is invoked.

The invocation module 502 invokes the popover program interface in response to an invocation signal being triggered by the interaction information. The user finds the interaction information of interest during the process of watching the livestream, and triggers the invocation signal of relevant information by clicking on the interaction information. In the case where the interaction information is clicked or pre-clicked by a user, the interaction information is presented as a short stay and/or a larger information font and/or a change in the color of the information and/or a flash of special effect expressions, in order to prompt the user to perform the clicking operation. The pre-clicking herein is the case where the user moves a mouse or a touch point to the interaction information without actually clicking. After the main program detects the invocation signal triggered by the user, the main program applies to invoke the third-party program interface, and requests to invoke the third-party program. The operation of invoking the popover program interface in response to the invocation signal being triggered by the interaction information requires to determine whether the invoking is valid. In the case where the invoking is determined to be valid, a valid invocation instruction is generated, and then the popover program interface is invoked.

The initiating module 503 is configured to initiate the popover program by invoking the popover program interface, and display the popover program in the display panel in the form of a popover. The popover program is initiated by invoking the popover program interface, the popover program performs the embedded display and operation in the main program. The display panel serves as the display window of the popover program, and the popover serves as the operation interface of the popover program. The popover program is a third-party program, the program has a shortcut operation and an attribute of being able to operate transfers, so that the program is embedded in the main program for the shortcut operation. The third-party program is displayed in the display panel in the target interface of the main program in the form of the popover, and the user operates according to the displayed operation options.

In one example, a certain area is divided from the target interface in advance as a display panel, and as the display area of the popover program. In respond to an invocation signal indicating that the user clicks on the interaction signal, the main program invokes a popover program interface, a certain area is divided from the livestream interface of the main program as a display panel, serving as a display area of the popover program. The display panel is allowed for position dragging according to the content distribution of the target interface of the main program, the position after dragging is any position in the target interface. The display panel is allowed for adjusting the size in the target interface of the main program, and the user adjusts the position and size of the display panel according to the change of the content in the livestream interface, desirably without obscuring the content that the user is concerned about.

The operation module 504 is configured to operate or switch the popover program. The user is interested in the relevant information of the interaction information, clicks on the relevant information of the interaction information, and the popover program is displayed in the display panel of the main program interface in the form of a popover. The popover is a shortcut operation option of the popover program. After the user operates through the shortcut operation option, the popover switches to another shortcut operation option. For example, in a resource transferring application, the user performs a selection operation through the popover option. In the case where the relevant operation is not found on the popover page, the sliding operation is performed, or the option of the next page is displayed for the user to select, another popover page is switched, and the user operates more than one times to find the relevant operation option until the user completes the operation.

Further, in response to the invocation signal being triggered by the interaction information, the invocation module invokes a popover program interface, further includes: determining whether the invoking is valid; generating a valid invocation instruction and invoking the popover program interface based on the valid invocation instruction, in the case where the invoking is determined to be valid.

Further, the invocation module determines whether the invoking is valid, includes: determining whether the invoking is valid according to the embedded authentication information between the popover program and the main program. In response to the embedded authentication information between the popover program and the main program being present, the invoking is valid, and in response to the embedded authentication information between the popover program and the main program being absent, the invoking is invalid.

Further, the display module is further configured to perform, for the popover program, an embedded display in the main program. The display panel serves as the display window of the popover program, and the popover serves as the operation interface of the popover program.

Further, the display module is further configured to dynamically adjust the display state, including adjusting the position and size of the display panel. The display panel is allowed for position dragging in accordance with the content distribution in the target interface of the main program, the position after dragging is any position in the target interface, and the display panel is allowed for the size adjustment in the target interface of the main program.

Further, the display module further includes a transparency attribute, the display panel has a transparency in the target interface of the main program, and the transparency is allowed to be adjusted in the range from 0 to 100.

Further, the display module is further configured to set the display panel and the popover program to be one or more than one. In the case where the popover programs are more than one, the more than one popover programs are displayed in the same display panel or in different display panels.

Further, the initiating module is further configured to: invoke and initiate, by the first popover program, the second popover program in the popover, after the first popover program is initiated based on invoking in the display panel. The second popover program is an associated program of the first popover program. For example, the first popover program is an e-commerce service program or a game program, and the associated second popover program is a resource transferring program.

Further, the operation module is further configured to, operate through the shortcut operation option according to the popover serving as a shortcut operation option of the popover program. The popover switches to another shortcut operation option until the user completes the operation. The popover program is an e-commerce service program, a resource transferring program, a social program, or a game program, and the user performs the shortcut operation on the program through the popover of the display panel.

The apparatus illustrated in FIG. 5 is allowed to execute the method of the embodiment illustrated in FIG. 1, and the portions not described in detail in the embodiment refer to the relevant description of the embodiment illustrated in FIG. 1. The execution process and technical effect of the technical solution refer to the description of the embodiment illustrated in FIG. 1, and are not repeated herein.

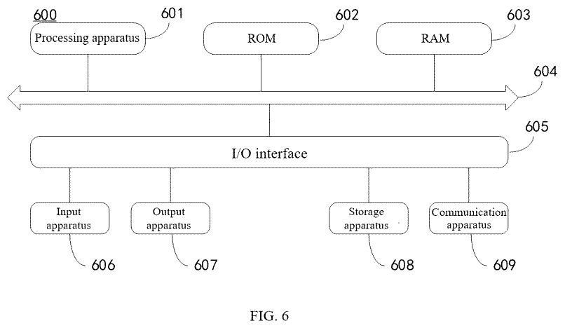

Referring to FIG. 6 below, FIG. 6 shows a structure diagram of an electronic device 600 suitable for implementing the embodiment of the present disclosure. A terminal equipment in the embodiment of the present disclosure includes, but is not limited to, mobile terminals such as mobile phones, laptops, digital broadcast receivers, personal digital assistants (PDAs), tablet computers (PAD), portable multimedia players (PMPs), vehicle terminals (such as car navigation terminals) and the like, and fixed terminals such as digital TVs, desktop computers, and etc. The electronic device illustrated in FIG. 6 is only an example and does bring any limitation on the functions and usage scope of the present embodiments.

As illustrated in FIG. 6, the electronic device 600 includes a processing apparatus (such as a central processing unit, a graphics processor, and etc.) 601, the processing apparatus executes various appropriate actions and processing according to a program stored in a read-only memory (ROM) 602 or a program loaded from the storage device 608 into a random access memory (RAM) 603. In RAM 603, various programs and data required for the operation of the electronic device 600 are also stored. A processing apparatus 601, ROM 602 and RAM 603 are connected to each other via a communication line 604. Input/output (I/O) interface 605 is also connected to the communication line 604.

Typically, the following apparatuses are allowed to connect to the I/O interface 605, including: an input apparatus 606 such as a touch screen, a touchpad, a keyboard, a mouse, a camera, a microphone, an accelerometer, a gyroscope, or the like; an output apparatus 607 such as a liquid crystal display (LCD), a speaker, a vibrator, or the like; a storage apparatus 608 such as a tape, hard disk, or the like; and a communication apparatus 609. The communication apparatus 609 allows the electronic device 600 to perform wireless or wire-lined communication with other devices to exchange data. Although FIG. 6 illustrates an electronic device 600 having various devices, it is understood that not all of the devices illustrated are necessarily implemented or included. More or fewer devices are allowed to be implemented or included alternatively.

Particularly, according to the embodiments of the present disclosure, the process of the description referring to the flowchart may be implemented as a computer software program. For example, the embodiments of the present disclosure include a computer program product, which includes a computer program carried on a non-transient computer-readable medium. The computer program includes program codes for performing the method illustrated in the flowchart. In such embodiments, the computer program is downloaded and installed from the network via the communication apparatus 609, or is installed from the storage apparatus 608, or is installed from the ROM 602. When the computer program is executed by the processing apparatus 601, the above functions as defined in the methods of the embodiments of the present disclosure are executed.

It is noted that the computer-readable medium in the present disclosure may be a computer-readable signal medium, or a computer-readable storage medium, or any combination thereof. The computer-readable storage medium, for example, may be, but not limited to, an electrical, magnetic, optical, electromagnetic, infrared, or semiconductor system, apparatus or device, or any combination of the above. More specific examples of the computer-readable storage medium may include, but not be limited to: an electrical connection with one or more than one wires, a portable computer disk, a hard disk, a random access memory (RAM), a read-only memory (ROM), an erasable programmable read-only memory (EPROM or flash memory), an optical fiber, a compact disk read-only memory (CD-ROM), an optical memory device, a magnetic memory device, or any suitable combination of the above. In the present disclosure, the computer-readable storage medium may be any tangible medium including or storing a program that can be used by or in combination with an instruction execution system, apparatus or device. In the present disclosure, the computer-readable signal medium may include a data signal that propagates in a baseband or as a part of a carrier, and the computer-readable signal medium carries the computer-readable program codes. The propagated data signal may take many forms, including but not limited to an electromagnetic signal, an optical signal, or any suitable combination of the above. The computer-readable signal medium may also be any computer-readable medium other than the computer-readable storage medium, the computer-readable signal medium may send, propagate, or transmit the program for being used by the instruction execution system, apparatus or device, or being used in combine with the computer-readable signal medium. The program code included on the computer-readable medium is allowed to be transmitted via any appropriate medium, including but not limited to: wires, optical cables, RF (radio frequency), and the like, or any suitable combination of the above.

In some embodiments, a client and a server may communicate with any network protocol currently known or to be researched and developed in the future such as hypertext transfer protocol (HTTP), and may communicate (via a communication network) and interconnect with digital data in any form or medium. Examples of communication networks include a local area network (“LAN”), a wide area network (“WAN”), an inter-network (e.g., the Internet), and end-to-end networks (e.g., ad hoc end-to-end networks), as well as any currently known or future developed networks.

The above computer-readable medium may be included in the electronic device described above; and may also exist alone and not be incorporated into the electronic device.

The above computer-readable medium carries one or more than one programs, in the case where one or more than one programs are executed by the electronic device, the electronic device performs the information interaction method of the above embodiment.

The computer program codes may be written in one or more than one programming languages or the combination thereof to execute the operation of the present disclosure. The programming languages include but are not limited to object-oriented programming languages such as Java, Smalltalk and C++, and also include a general procedural programming language such as “C” language or similar programming languages. The program code may be executed entirely on the computer of the user, be executed partially on the computer of the user, be executed as an independent software package, be executed partially on the computer of the user and partially on a remote computer, or be executed entirely on a remote computer or a server. In the case where the remote computer is involved, the remote computer may be connect to the computer of the user through any type of networks, including a local area network (LAN) or a wide area network (WAN), or the remote computer may be connect to an external computer (for example, utilize an Internet service provider to connect via the Internet).

The flowchart and block diagram in the accompanying drawings illustrate architectures, functions and operations, which may be implemented according to the systems, methods and computer program products of the various embodiments of the present disclosure. In this regard, each block of the flowchart or block diagram may represent a module, a segment, or a portion of codes, and the module, the segment, or the portion of the codes, including one or more than one executable instructions for implementing the specified logical functions. It is also noted that in some alternative implementations, the functions indicated in the block may also occur out of the order noted in the accompanying drawings. For example, two blocks illustrated in succession may be executed substantially concurrently, and sometimes may be executed in a reverse order, depending on the involved function. It is also noted that each block of the block diagram and/or flowchart, and the combination of blocks of the block diagram and/or flowchart, may be implemented by using a dedicated hardware-based system for executing a specified function or operation, or may also be implemented by a combination of the dedicated hardware and the computer instructions.

The involved unit in the embodiments of the present disclosure may be implemented by the mean of the software or by the mean of the hardware, the name of the unit does not constitute a limitation to the unit itself in a certain circumstance.

The functions described above in this article may be executed, at least in part, by one or more than one hardware logic devices. For example, non-restrictively, the exemplary hardware logic devices that are allowed to be used, include: a field programmable gate array (FPGA), an application specific integrated circuit (ASIC), an application specific standard product (ASSP), a system on chip (SOC), a complex programmable logical device (CPLD), and so on.

In the context of the present disclosure, the machine-readable medium is allowed to be a tangible medium, and the machine-readable medium may include or store a program used by the instruction execution system, the apparatus or the device, or used in combination with the instruction execution system, the apparatus or the device. The machine-readable medium may be a machine-readable signal medium or a machine-readable storage medium. The machine-readable medium may include, but be not limited to, electronic, magnetic, optical, electromagnetic, infrared, or semiconductor systems, apparatuses or devices, or any suitable combination of the above. More specific examples of the machine-readable storage medium include electrical connections based on one or more than one wires, portable laptop disks, hard disks, random access memory (RAM), read only memory (ROM), erasable programmable read-only memory (EPROM or flash memory), optical optics, compact disk read-only memory (CD-ROM), optical storage devices, magnetic storage devices, or any suitable combination of the above.

According to one or more than one embodiments of the present disclosure, an electronic device is provided, which includes: at least one processor; and a memory communicatively connected to the at least one processor. The memory stores instructions that are allowed to be executed by the at least one processor, the instructions are executed by the at least one processor so that the at least one processor is allowed to execute the information interaction method of any one in the first aspect.

According to one or more than one embodiments of the present disclosure, a non-transient computer-readable storage medium is provided. The non-transient computer-readable storage medium stores computer instructions, the computer instructions are configured to enable a computer to execute the interaction method of any one in the first aspect.

The above description is only a better embodiment of the present disclosure and a description of the used technical principle. Those skilled in the art should understand that the disclosure scope involved in the present disclosure is not limited to the technical solution of a specific combination of the technical features, but also covers other technical solutions formed by any combination of the above technical features or the equivalent features without departing from the disclosure ideas. For example, a technical solution is formed by substituting the features and the technical features with similar functions disclosed (but not limited to) in the present disclosure.

1. An information interaction method, comprising:
displaying interaction information in a target interface of a first program;
invoking a second program interface in response to an invocation signal being triggered by the interaction information;
initiating a second program by invoking the second program interface, and displaying the second program in a display panel; and
operating or switching the second program.

2. The information interaction method of claim 1, wherein after invoking the second program interface and before initiating the second program by invoking the second program interface, the method further comprises:
dividing a certain area in the target interface as the display panel, and
wherein the display panel serves as a display area of the second program.

3. The information interaction method of claim 1, wherein the invoking a second program interface in response to an invocation signal being triggered by the interaction information, comprises:
determining whether the invoking is valid; and
generating a valid invocation instruction in a case where the invoking is determined to be valid, and invoking the second program interface based on the valid invocation instruction.

4. The information interaction method of claim 3, wherein the determining whether the invoking is valid comprises:
determining whether the invoking is valid according to embedded authentication information between the second program and the first program; and
wherein in response to the embedded authentication information between the second program and the first program being present, the invoking is valid, and in response to the embedded authentication information between the second program and the first program being absent, the invoking is invalid.

5. The information interaction method of claim 1, wherein the first program is a livestream program, a game program, or a video program, and the target interface of the first program is a livestream interface, a game interface, or a video interface.

6. The information interaction method of claim 1, wherein the display panel is allowed for position dragging in accordance with a content distribution in the target interface of the first program, and a position after being dragged is any position in the target interface.

7. The information interaction method of claim 1, wherein the display panel is allowed for adjusting a size in the target interface of the first program.

8. The information interaction method of claim 1, wherein the display panel has a transparency in the target interface of the first program, and the transparency is allowed to be adjusted in a range from 0 to 100.

9. The information interaction method of claim 1, wherein the second program performs an embedded display and operation in the first program; and
wherein the display panel serves as a display window of the second program, and a popover serves as an operation interface of the second program.

10. The information interaction method of claim 1, wherein the second program is an e-commerce service program, a social program, or a game program, and a user performs a shortcut operation on the second program through a popover of the display panel.

11. The information interaction method of claim 1, wherein a popover is a shortcut operation option of the second program; and
wherein after a user performs an operation through the shortcut operation option, the popover is switched to another shortcut operation option.

12. The information interaction method of claim 1, wherein both of the display panel and the second program are allowed to be set to be one or more than one.

13. The information interaction method of claim 12, wherein in a case where the second programs are more than one, more than one second programs are displayed in a same display panel or in different display panels.

14. The information interaction method of claim 1, wherein the second program comprises a third program and a fourth program, the third program is initiated in the display panel based on the invoking, the fourth program is an associated program of the third program, and the fourth program is initiated by an invocation of the third program in a popover.

15. An information interaction apparatus, comprising:
a display module, configured to display interaction information in a target interface of a first program;
an invocation module, configured to in response to an invocation signal being triggered by the interaction information, invoking a second program interface;
an initiating module, configured to initiate a second program by invoking the second program interface, and to display the second program in a display panel; and
an operation module, configured to operate or switch the second program.

16. An electronic device, comprising:
a memory, configured to store computer-readable instructions; and
a processor, configured to execute the computer-readable instructions, so that the electronic device implements an information interaction method, and the information interaction method comprises:
displaying interaction information in a target interface of a first program;
invoking a second program interface in response to an invocation signal being triggered by the interaction information;
initiating a second program by invoking the second program interface, and displaying the second program in a display panel; and
operating or switching the second program.

17. A computer-readable storage medium storing computer-readable instructions, wherein the computer-readable instructions upon execution by a computer, cause the computer to implement the method of claim 1.

18. (canceled)

19. The information interaction method of claim 1, wherein the first program is a main program, the second program is a popover program, and the second program is displayed in the display panel in a form of a popover.

20. The information interaction method of claim 14, wherein the third program is a popover program, and the fourth program is a popover program.
